(19) United States
(12) Patent Application Publication
(10) Pub. No.: US 2009/0118046 A1
(43) Pub. Date: May 7, 2009

(54) Multi-speed bicycle sprocket

(76) Inventor: Sen-Biao Lai, Taichung County (TW)

Correspondence Address: Lai, Sen-Biao, P.O. Box 44-2049, Taipei, 10668, TW

(21) Appl. No.: 11/979,378

(22) Filed: Nov. 2, 2007

(51) Int. Cl. F16H 55/30

(52) U.S. Cl. 474/160

(57) ABSTRACT

An improvement of a multi-speed bicycle sprocket, in which the number of teeth of a tenth sprocket of a rear sprocket assembly is increased to obtain a more laborsaving effect without significantly changing a multi-speed bicycle chain and a rear derailleur. The number of teeth of the tenth sprocket with the maximum outer diameter is increased from 27 teeth to 28 or more than 28 teeth. Preferably, the tenth sprocket has 32 teeth. Therefore, the speed ratio of the tenth sprocket of the rear sprocket assembly to a front sprocket assembly approximates to 1:1 so that a rider or a player may ride the bicycle and/or ride the bicycle uphill in a more laborsaving manner.

### BACKGROUND OF THE INVENTION

(1) Field of the Invention

The invention relates to an improvement of a multi-speed bicycle sprocket, in which the number of teeth of a tenth sprocket of a rear sprocket assembly is increased to obtain a more laborsaving effect without significantly changing a multi-speed bicycle chain and a rear derailleur. The number of teeth of the tenth sprocket with the maximum outer diameter is increased to 28 or more than 28 teeth. Preferably, the tenth sprocket has 32 teeth. Therefore, the speed ratio of the tenth sprocket of the rear sprocket assembly to a front sprocket assembly approximates to 1:1 so that a rider or a player may ride the bicycle and/or ride the bicycle uphill in a more laborsaving manner.

(2) Description of the Prior Art

Bicycles have been used for a long period of time and have played important roles in traffic tools when vehicles and motorcycles are not popularized. With the progress of the technology and the requirement of the consumer, the usage of the bicycle has been transferred to the aspects of leisure and exercise. The type of the bicycle has been designed to be more light and portable and to have a multi-speed function so that the bicycle rider can ride the bicycle in any road with a proper speed. Thus, the rider can ride the bicycle in a laborsaving manner. Therefore, the design of the bicycle derailleur is a great breakthrough in the bicycle industry.

Typically, a multi-speed bicycle mainly has a front big sprocket assembly and a rear sprocket assembly, which is attached to a rear wheel. At present, the front big sprocket assembly has two or three sprockets, and the rear sprocket assembly has 5 to 10 sprockets. In addition, a rear derailleur is attached to a bottom end of the rear sprocket assembly so that a chain can pass through it and the speed can be changed.

At present, the maximum number of sprockets of the rear sprocket assembly of the bicycle is 10 so that ten speed ratios can be obtained. FIG. 3 is a schematic plane view showing a tenth sprocket of a conventional multi-speed bicycle. As shown in FIG. 3, the number of teeth (A1) of the conventional tenth sprocket (A) is 27 and is never increased heretofore. Because the number of teeth (A1) is 27, the tenth sprocket (A) of the rear sprocket assembly has not been rotated by 360 degrees (see the arrow in the sprocket of FIG. 4) when the front sprocket (B) is rotated by 360 degrees. Thus, the rider has to apply a bigger force by his/her feet, and the laborsaving effect cannot be effectively achieved if the rider is riding for a long time or when the rider is riding the bicycle uphill for a long distance. A1so, if the number of teeth (A1) of the conventional tenth sprocket (A) is increased to more than 27, the length of the chain and the rear derailleur have to be modified so that the consumer has to pay for the extra expenditure and the consumer will encounter troubles.

### SUMMARY OF THE INVENTION

It is therefore an object of the invention to solve the problems caused by a tenth sprocket of the conventional multi-speed bicycle. In view of the associated problems induced by the design defects of the conventional tenth sprocket, the present inventor has paid attention to the research and development according to the experience and the technology in manufacturing the associated products for many years, and thus developed this improvement of a multi-speed bicycle sprocket.

To achieve the above-mentioned object, the invention provides an improvement of a multi-speed bicycle sprocket, in which the number of teeth of a tenth sprocket with the maximum outer diameter is increased to 28 or more than 28 teeth. Therefore, the speed ratio of the tenth sprocket of a rear sprocket assembly to a front sprocket assembly approximates to 1:1, as shown in FIG. 2. Consequently, the number of teeth of the tenth sprocket of a rear sprocket assembly is increased to obtain a more laborsaving effect without significantly changing a multi-speed bicycle chain and a rear derailleur. Thus, a rider or a player may ride the bicycle and/or ride the bicycle uphill in a more laborsaving manner.

Another object of the invention is to provide an improvement of a multi-speed bicycle sprocket, wherein a tenth sprocket with the maximum outer diameter has 32 teeth.

Further aspects, objects, and desirable features of the invention will be better understood from the detailed description and drawings that follow in which various embodiments of the disclosed invention are illustrated by way of examples.

### BRIEF DESCRIPTION OF THE DRAWINGS

FIG. 1 is a schematic plane view showing a multi-speed bicycle sprocket according to the invention.

FIG. 2 is a schematic plane view showing a speed ratio of the multi-speed bicycle sprocket to a front sprocket assembly according to the invention.

FIG. 3 is a schematic plane view showing a tenth sprocket of a conventional multi-speed bicycle.

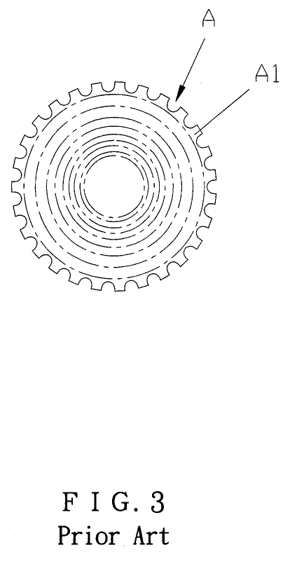

FIG. 4 is a schematic plane view showing a speed ratio of a tenth sprocket, which has a maximum outer diameter, to a front sprocket assembly in the conventional multi-speed bicycle.

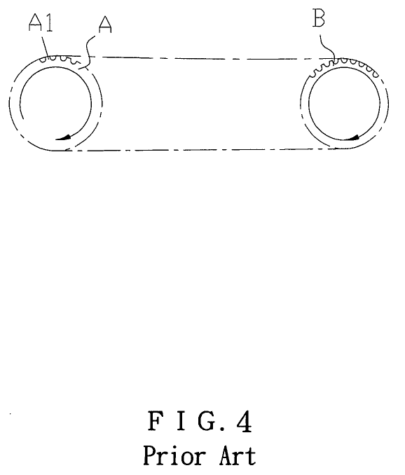

### DETAILED DESCRIPTION OF THE PREFERRED EMBODIMENTS

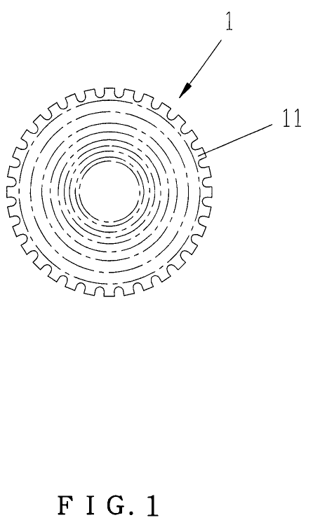

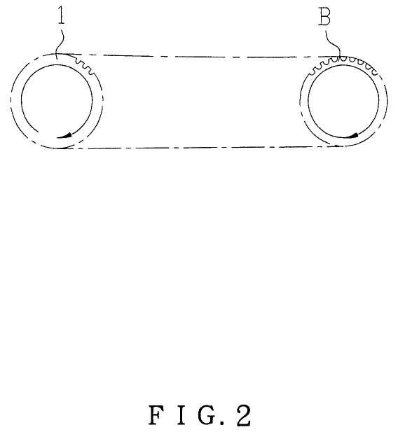

FIG. 1 is a schematic plane view showing a multi-speed bicycle sprocket according to the invention. As shown in FIG. 1, the improvement of the multi-speed bicycle sprocket is provided. The number of teeth (11) of a tenth sprocket (1) with the maximum outer diameter is increased to 28 or more than 28 teeth. Preferably, the tenth sprocket has 32 teeth. Therefore, the speed ratio of the tenth sprocket (1) of a rear sprocket assembly to a front sprocket assembly (B) approximates to 1:1, as shown in FIG. 2. Consequently, the number of teeth (11) of the tenth sprocket (1) of the rear sprocket assembly is increased to obtain a more laborsaving effect without significantly changing a multi-speed bicycle chain and a rear derailleur. Thus, a rider or a player may ride the bicycle and/or ride the bicycle uphill in a more laborsaving manner.

In summary, the improvement of the multi-speed bicycle sprocket of the invention has indeed improved the conventional drawbacks. New characteristics and advantages of the invention covered by this document have been set forth in the foregoing description. It is to be expressly understood, however, that the drawings are for the purpose of illustration only and are not intended as a definition of the limits of the invention. Changes in methods, shapes, structures or devices may be made in details without exceeding the scope of the invention by those who are skilled in the art. The scope of the invention is, of course, defined in the language in which the appended claims are expressed.

What is claimed is:

1. An improvement of a multi-speed bicycle sprocket, characterized in that a rear sprocket assembly having a tenth sprocket with a maximum outer diameter has 28 or more than 28 teeth.

2. The improvement of the multi-speed bicycle sprocket, wherein the tenth sprocket has 32 teeth.
